(19) United States
(12) Patent Application Publication
(10) Pub. No.: US 2014/0060152 A1
(43) Pub. Date: Mar. 6, 2014

(54) Method for Chromatographic Analysis of a Hydrogen-Containing Gas Mixture

(71) Applicants: Frank Probst, Herxheim bei Landau/Pfalz (DE); Piotr Strauch, Rulzheim (DE)

(72) Inventors: Frank Probst, Herxheim bei Landau/Pfalz (DE); Piotr Strauch, Rulzheim (DE)

(21) Appl. No.: 14/007,345

(22) PCT Filed: Mar. 29, 2012
(86) PCT No.: PCT/EP2012/055587

§ 371 Date: Nov. 13, 2013

(30) Foreign Application Priority Data
Mar. 30, 2011 (DE) 10 2011 006 452.4

(51) Int. Cl. G01N 30/86

(52) U.S. Cl. CPC G01N 30/86
USPC 73/23.41

(57) ABSTRACT

Method for chromatographic analysis of a hydrogen-containing gas mixture, wherein a first dose of the gas mixture is guided through a separation device using helium as a carrier gas during a first measurement pass and concentrations of separated components are measured, the concentration of the hydrogen in the gas mixture is measured and the measurement value is obtained up to an upper limit value in the range from 5% to 6%, and a second dose of the same gas mixture is guided through the separation device using the same carrier gas during a second measurement pass, wherein as compared to the first measurement pass the dose is reduced, the gas mixture is volumetrically diluted and/or the carrier-gas speed is reduced, and the hydrogen concentration is re-measured, and the measurement value obtained during the first measurement pass is verified against the measurement value obtained in the second measurement pass.

### CROSS-REFERENCE TO RELATED APPLICATIONS

This is a U.S. national stage of application No. PCT/EP2012/055587 filed 29 Mar. 2012. Priority is claimed on German Application No. 10 2011 006 452.4 filed 30 Mar. 2011, the content of which is incorporated herein by reference in its entirety.

### BACKGROUND OF THE INVENTION

1. Field of the Invention

The invention relates to gas chromatography and, more particularly, to a method for chromatographic analysis of a hydrogen-containing gas mixture.

2. Description of the Related Art

In the case of gas chromatography, a dose of a gas mixture to be analyzed is introduced into a carrier gas flow and guided by means thereof through a separating device consisting of one or more separating columns. Because of varying interaction with the material of the separating device, the various components of the gas mixture successively exit from the separating device separately from one another. A thermal conductivity detector is preferably used at the outlet of the separating device to detect the arriving separated components. On the one hand, in principle all gas components may be detected using a thermal conductivity detector, which is advantageous particularly in the case of a multiplicity of components to be detected. On the other hand, a thermal conductivity detector does not require any further operating gases in addition to the carrier gas. The detection of the individual components using the thermal conductivity detector is based on the different thermal conductivities thereof with respect to that of the carrier gas. Helium, nitrogen, argon, or hydrogen, is frequently used as a carrier gas. Hydrogen and helium allow, with the high thermal conductivity difference thereof from other components, particularly sensitive detection of these other components.

The gas-chromatography analysis of combustion gases also includes, in addition to the detection of a multiplicity of different hydrocarbons and also of (inter alia) oxygen, nitrogen, and carbon dioxide, the detection of hydrogen. Therefore, practically only helium comes into consideration as a carrier gas. The problem occurs in this case that helium as a carrier gas does not allow unambiguous detection of hydrogen by a thermal conductivity detector.

With the exception of hydrogen, the thermal conductivity of the components to be detected is less than that of the carrier gas helium, so that the thermal conductivity detector generates a signal as a positive peak upon detection of each of these components, the area of this peak being proportional to the concentration of the detected components. Since the thermal conductivity of hydrogen is greater than that of helium, a negative peak would be expected. In fact, at low concentrations up to approximately 5 to 10% hydrogen in helium, a positive peak is obtained. A valley is then formed at the tip of the peak at higher hydrogen concentrations, that grows to form a negative peak which becomes increasingly large with further increasing concentration of the hydrogen. Thus, if a corresponding hydrogen-helium mixture is used as a carrier gas, a negative peak is obtained at every concentration of the component hydrogen to be detected. The solution of this approach is known, for example, from Don E. Clay et al.: “Single Detector Analysis of Refinery Gases”, Application Note 10090, Thermo Electron Corporation, Jan. 21, 2011, where a carrier gas mixture made of 8.5% hydrogen in helium is used and the negative signal of the thermal conductivity detector is inverted upon the appearance of the hydrogen component. Such a gas mixture is not conventionally available on the market, and the production thereof with appropriately high precision is costly.

Alternatively to the solution of the above-mentioned problem, different carrier gases can be used to detect the hydrogen and that of the other components. It is thus possible after a double sampling to assay one sample for hydrocarbons in a separating device using the carrier gas helium and to assay the second sample for hydrogen either subsequently in the same separating device or in parallel in a further separating device using the carrier gas argon or nitrogen.

From JP 6-258306 A, it is known to change the carrier gas used during the gas-chromatography analysis of a gas mixture containing hydrogen and hydrocarbons. Firstly, the sample is conducted via nitrogen as a first carrier gas through a separating device consisting of two separating sections, at the end of which separating device the hydrogen is detected and quantitatively determined. Subsequently, the hydrocarbons, after they have reached the second separating section, are conducted through it via helium as a second carrier gas to the detector, while the first separating section is back-flushed using the nitrogen. The carrier gas changeover in the middle of the separating device can be problematic, because the hydrocarbons are initially still contained in the nitrogen and only acquired by the helium in the further course of the second separating section.

Conducting a sample of a gas mixture containing hydrogen and hydrocarbons via helium as a first carrier gas in a separating device and, after the component hydrogen has passed through at least a part of the separating device, flushing this part of the separating device using argon or nitrogen as a second carrier gas, and subsequently conducting a further sample into the separating device via the second carrier gas is known from DE 10 2008 061 158 B1. Alternatively, argon or nitrogen is used as a first carrier gas and, after the hydrocarbons of interest have passed through at least a part of the separating device, this part of the separating device is flushed using helium as a second carrier gas, and subsequently a further sample is conducted into the separating device via the second carrier gas.

### SUMMARY OF THE INVENTION

It is an object of the invention to reliably and precisely determine the hydrogen content of a gas mixture up to a concentration of approximately 5% to 6% during chromatographic analysis of a gas mixture, without the determination of further components of the gas mixture being impaired or a carrier gas change being necessary. Hydrogen concentrations greater than 5% to 6% are also able to be measured, although having a high measurement error.

This and other objects and advantages are achieved in accordance with the invention by providing a method for the chromatographic analysis of a hydrogen-containing gas mixture, where in a first measurement procedure, a first dose of a gas mixture is conducted via helium as a carrier gas through a separating device and the concentrations of separated components of interest are measured, where the concentration of the hydrogen in the gas mixture is measured by a thermal conductivity detector and the measured value obtained thereby is accepted up to an upper limiting value in the range from 5% to 6%. In a second measurement procedure, a second dose of the same gas mixture is conducted via the same carrier gas through the separating device, where, in contrast to the first measurement procedure, the dose is reduced, the gas mixture is volumetrically diluted, and/or the carrier gas speed is reduced, and the concentration of the hydrogen in the gas mixture is re-measured by the thermal conductivity detector.

Moreover, measured value accepted from the first measurement procedure is verified using the measured value obtained in the second measurement procedure.

In the first measurement procedure, all components of interest of the gas mixture to be analyzed, including the hydrogen, can be measured with a high degree of precision. The measurement range for hydrogen, which extends up to approximately 5% to 6%, is often sufficient in practice. In the second measurement procedure, only hydrogen is still measured in principle. It is conceivable to also still determine methane at the same time, for example, and calculate it as a reference for scaling purposes. Because of the lower dosage, volumetric dilution of the gas mixture, and/or reduced carrier gas speed, the measurement error for hydrogen concentrations less than approximately 10% is increased, but the measurement range is expanded. Therefore, a check can be performed based on the measured value obtained in the second measurement procedure to determine whether the measurement range was exceeded in the first measurement procedure, but this was not recognized as a result of the ambiguity of the first measured value.

At hydrogen concentrations above approximately 10%, the measurement error of the second measurement procedure is greater than in the first measurement procedure. Therefore, hydrogen concentrations beyond the limiting value in the range from 5% to 6% of the first measurement procedure, up to 20%, for example, can be measured in the second measurement procedure.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

For further explanation of the invention, reference is made hereafter to the figures of the drawing, in which:

FIG. 1 shows a simple example of a gas chromatograph for performing the method in accordance with the invention;

FIG. 2 shows an example of the signal of a thermal conductivity detector during detection of a hydrogen fraction in helium;

FIG. 3 shows a graphical plot of an exemplary an example of the relationship between the concentration of the hydrogen in a gas mixture to be analyzed and the measured value obtained by thermal conductivity measurement of the chromatographically separated hydrogen fraction;

FIG. 4 shows an enlarged detail from the graphical plot of FIG. 3; and

FIG. 5 is a flowchart of the method in accordance with the invention.

### DETAILED DESCRIPTION OF THE PREFERRED EMBODIMENTS

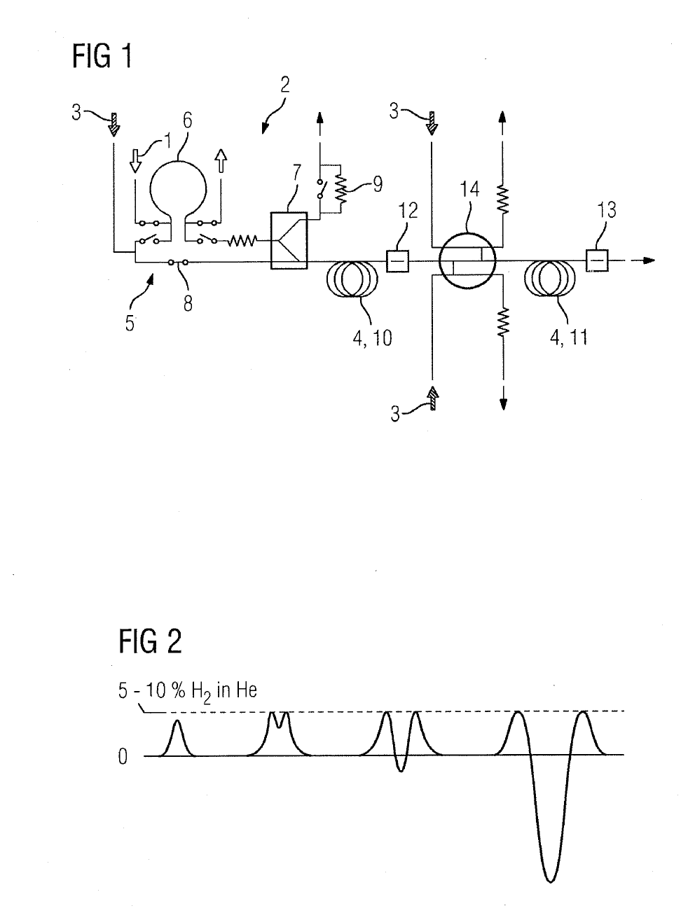

In the gas chromatograph shown in a schematic illustration in FIG. 1, a gas mixture 1 to be analyzed is supplied to a dosing device 2 after withdrawal from a technical process. The dosing device 2 is used for the purpose of inwardly transferring at a predefined point in time a predefined dose of the gas mixture 1 in the form of a short and sharply delimited sample plug into a carrier gas flow 3 and feeding it to a separating device 4. The dosing device 2 has a dosing valve 5 which, in a first switch position shown here, conducts the gas mixture 1 into a sample loop 6. In a second switch position, the sample loop 6 is switched into the path of the carrier gas 3, which feeds the sample of the gas mixture 1, which is contained in the sample loop 6, to an injector 7. As long as a solenoid valve 8 is open, the carrier gas 3 flows through the solenoid valve 8 and the injector 7 into the separating device 4, while the sample is discharged outward from the sample loop 6 via a flow throttle 9. If the solenoid valve 8 is closed for a predefined duration, a part is branched off from the sample in the injector 7 and transferred inward as a sharply delimited sample plug into the carrier gas stream 3 to the separating device 4. As the gas mixture 1 flows through the separating device 4, the components of the gas mixture 1 contained in the sample plug are separated.

The separating device 4 shown as an example here consists of two or more successive separating arrangements 10, 11, which in turn each have one or more separating columns connected in series, having different separating properties. Respectively one thermal conductivity detector 12, 13 for detection of the components of interest, which have been completely separated up to this point, of the gas mixture 1 are arranged at the end of each separating arrangement 10, 11 or each separating column, respectively. A gas changeover device 14 is incorporated between the separating arrangements 10 and 11, which allows components, which have been completely separated and detected up to this point, to be transferred out of the separating device 4 and both separating arrangements 10 and 11 to be flushed with the carrier gas 3 independently of one another.

The gas mixture 1 is, for example, combustion gas, in which a plurality of components, also including hydrogen, are to be quantitatively detected. Pure helium is used as carrier gas 3. The rear separating arrangement 11 is implemented as a molecular sieve to separate the hydrogen from nitrogen and methane, for example. The detection of hydrogen, nitrogen, and methane is therefore performed in the thermal conductivity detector 13. Nitrogen and methane each have lower thermal conductivities than helium, so that the thermal conductivity detector 13 generates a positive peak signal each time upon detection, the area (or else height) of which is proportional to the nitrogen or methane quantity. In contrast, the thermal conductivity of a hydrogen-helium mixture behaves completely differently and abnormally.

FIG. 2 shows four peak signals of a thermal conductivity detector in the case of concentration of hydrogen in helium that increases from left to right. Up to a concentration of mixture increases, to then drop again with further increasing concentration of hydrogen in helium. As a result, at higher hydrogen concentrations, a valley forms at the tip of the peak signal, which grows to form a negative peak that becomes larger and larger with further increasing concentration of the hydrogen. The area under the four peaks thus initially increases, and then drops, so that ambiguities arise during the hydrogen measurement.

In accordance with the method of the invention, in a first measurement procedure, a first dose of the gas mixture 1 is now conducted via the carrier gas helium 3 through the separating device 4, where the concentrations of the components of interest are measured. The dose, i.e., the injected sample plug, and the carrier gas speed are dimensioned with regard to rapid and optimum separation and detection of the components. The molecular sieve column 11 is in particular sufficiently long, at 6 m, to sufficiently separate the hydrogen from the other components, so that the separated hydrogen fraction has the form of a relatively sharp peak. The peak concentration of the hydrogen in the helium is therefore in the magnitude range of the concentration of the hydrogen in the gas mixture 1 to be analyzed.

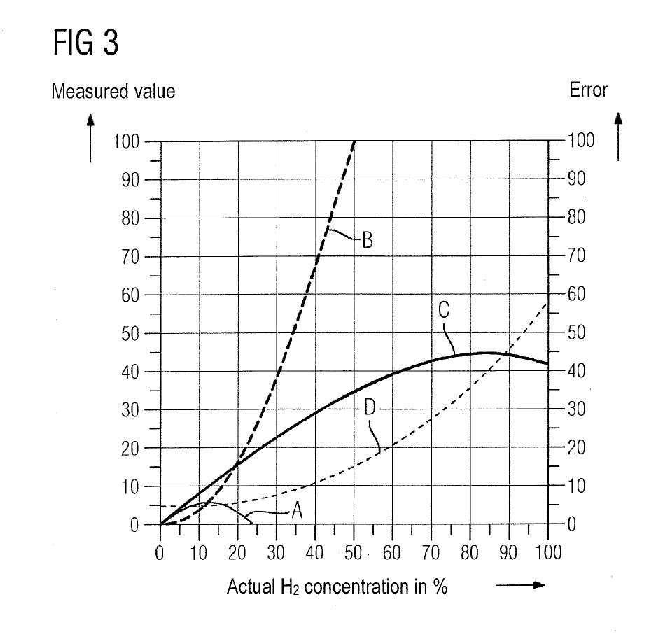

In FIG. 3, the curve A shows as an exemplary relationship between the actual concentration of the hydrogen in the gas mixture and the measured value (peak area) obtained by the thermal conductivity measurement. Up to a concentration of approximately 5% to 6%, this relationship is linear. In addition, up to approximately 10%, a function that still rises monotonously but is no longer linear is obtained. Beyond approximately 10%, the measured value would decrease again in spite of increasing hydrogen concentration and therefore assume a very high measurement error. The curve B shows the absolute measurement error associated with the curve A.

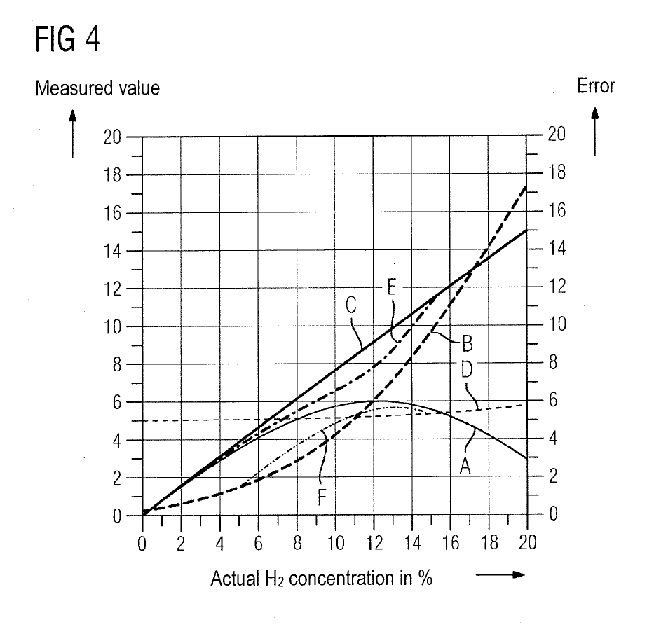

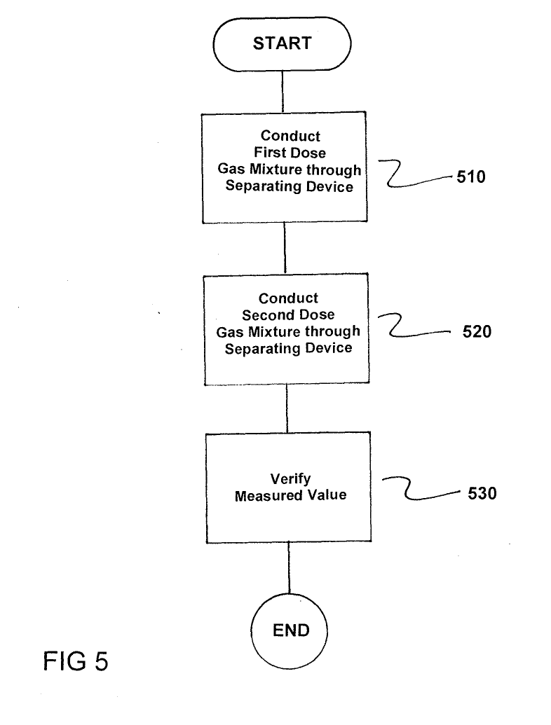

FIG. 4 shows an enlarged detail of the graphical plot shown in FIG. 3 for concentrations of the hydrogen in the gas mixture 1 up to a value of 20%.

In accordance with the method according of the invention, the measured value obtained in the first measurement procedure is accepted up to an upper limiting value in the range from 5% to 6%. Subsequently, in a second measurement procedure, a second dose of the same gas mixture 1 is conducted by via the same carrier gas 3 through the separating device 4, where, however, in contrast to the first measurement procedure, the dose is reduced, the gas mixture 1 is volumetrically diluted, and/or the carrier gas speed is reduced. The two first-mentioned measures directly result, and the third measure indirectly results, as a result of the peak widening, in a reduction of the peak height of the separated hydrogen fraction. Since the separating power of the gas chromatograph is reduced by the above-mentioned measures, no other components of the gas mixture are measured with the exception of the hydrogen.

In FIG. 3, the curve C shows an exemplary relationship between the actual concentration of the hydrogen in the gas mixture and the measured value obtained in the second measurement procedure by the thermal conductivity measurement. The monotonous dependence ends here only at a concentration of the hydrogen in the gas mixture of approximately 80%. As the curve D shows, however, the measurement error is up to approximately 10% higher than in the first measurement procedure as a result of the ambient noise in the concentration range. In any case, however, the measured value obtained in the second measurement procedure is suitable for verifying the measured value accepted in the first measurement procedure. Thus, if the first measurement procedure provides a measured value of 5% and the second measurement procedure provides a measured value of 12%, the measured value of the first measurement procedure is based on exceeding the measurement range (limiting value in the range from 5% to 6%), so that a corresponding error message is generated.

As already mentioned above, via the reduction of the dose of the gas mixture 1 injected into the carrier gas flow 3, the dilution of the gas mixture 1, before it is conducted into the sample loop 6, and/or via the reduction of the carrier gas speed, the peak height of the separated hydrogen fraction, i.e., the peak concentration of the hydrogen in the helium, is reduced. By virtue of the fact that the dose, the dilution of the gas mixture 1, and/or the carrier gas speed in the second measurement procedure are now set such that up to a predefined concentration of the hydrogen in the gas mixture 1, the concentration of the separated hydrogen fraction arriving at thermal conductivity detector 13 in the carrier gas 3 is less than the above-mentioned limiting value in the range from 5% to 6%, a measurement range expansion up to this predefined concentration, in the example shown approximately 80%, is possible, where, however, the measurement error increases. If a measurement error of approximately 5% is tolerated, a measurement range expansion in the second measurement procedure up to a concentration of the hydrogen in the gas mixture 1 of approximately 20% is possible. That is, concentrations of the hydrogen in the gas mixture 1 are measured up to approximately 5% to 6% in the first measurement procedure and verified in the second measurement procedure, while concentrations exceeding this, up to approximately 20%, are measured in the second measurement procedure.

As FIG. 4 shows, the measurement error B occurring in the first measurement procedure is less than the measurement error from the second measurement procedure up to a concentration of the hydrogen in the gas mixture 1 of approximately 10%. In addition, the second measurement procedure provides a higher precision. It is therefore advantageous, during the measurement of concentrations of the hydrogen in the gas mixture 1 greater than approximately 5% to 6%, to weight the measured value obtained in the second measurement procedure with the measured value from the first measurement procedure, by virtue of the fact that, for example, an average value of both measured values is obtained in the case of weighting of the measured values with the inverse value of the estimated measurement error. Therefore, the transition E shown in FIG. 4 from the curve A to the curve C is obtained for the dependence between the measured value and the actual concentration of the hydrogen in the gas mixture 1, and the transition F from the curve B to the curve D is obtained for the resulting measurement error.

FIG. 5 is a flowchart of a method for chromatographic analysis of a hydrogen-containing gas mixture. The method comprise conducting a first dose of the hydrogen-containing gas mixture via helium as a carrier gas through a separating device during a first measurement procedure and measuring concentrations of separated components of interest during the first measurement procedure, as indicated in step 510. Here, a concentration of hydrogen in the hydrogen containing gas mixture is measured by a thermal conductivity detector and an measured value that is obtained is accepted up to an upper value in a range from 5% to 6%.

Next, a second dose of the same hydrogen containing gas mixture is conducted through the separating device via the same carrier gas, as indicated in step 520. Here, in contrast to the first measurement procedure, either (i) the second dose is reduced during a second measurement procedure, (ii) the second dose of the same hydrogen containing gas mixture is volumetrically diluted during the second measurement procedure and/or (iii) the speed of the carrier is reduced during the second measurement procedure, and the concentration of the hydrogen in the hydrogen containing gas mixture is re-measured by the thermal conductivity detector.

The measured value accepted from the first measurement procedure is now verified using the re-measured value obtained during the second measurement procedure, as indicated in step 530.

While there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-3. (canceled)

4. A method for chromatographic analysis of a hydrogen-containing gas mixture, the method comprising:
conducting a first dose of the hydrogen-containing gas mixture via helium as a carrier gas through a separating device during a first measurement procedure and measuring concentrations of separated components of interest during the first measurement procedure, a concentration of hydrogen in the hydrogen-containing gas mixture being measured by a thermal conductivity detector and an obtained measured value being accepted up to an upper limiting value in a range from 5% to 6%;
conducting a second dose of the same hydrogen-containing gas mixture via the same carrier gas through the separating device, wherein, in contrast to the first measurement procedure, at least one of (i) the second dose being reduced during a second measurement procedure, (ii) the second dose of the same hydrogen-containing gas mixture being volumetrically diluted during the second measurement procedure and (iii) a speed of the carrier being reduced during the second measurement procedure, and the concentration of the hydrogen in the hydrogen-containing gas mixture being re-measured by the thermal conductivity detector; and
verifying the measured value accepted from the first measurement procedure using the re-measured value obtained during the second measurement procedure.

5. The method as claimed in claim 4, wherein at least one of the second dose of the same hydrogen-containing gas mixture, a dilution of the hydrogen-containing gas mixture and the speed of the carrier gas speed is set during the second measurement procedure such that up to a predefined concentration of the hydrogen in the hydrogen-containing gas mixture, the concentration of a separated hydrogen fraction, which arrives at the thermal conductivity detector, in the carrier gas is less than a limiting value in the range from 5% to 6%; and
wherein the re-measured value obtained during the second measurement procedure is accepted if the re-measured value lies below the predefined concentration of the hydrogen in the hydrogen-containing gas mixture and the measured value obtained during the first measurement procedure has not been accepted because of exceeding the upper limiting value.

6. The method as claimed in claim 5, wherein the re-measured value accepted during the second measurement procedure is corrected, during an interval following the upper limiting value, by weighting with the measured value obtained during the first measurement procedure.
